(19) United States
(12) Patent Application Publication
(10) Pub. No.: US 2021/0318487 A1
(43) Pub. Date: Oct. 14, 2021

(54) Bend Tolerant Dual-Core Fiber and Cable for Balanced Photonic Links

(71) Applicant: United States of America, as represented by the Secretary of the Navy, Patuxent River, MD (US)

(72) Inventors: Mark Beranek, Hollywood, MD (US); John Diehl, Clinton, MD (US); Jason McKinney, Bowie, MD (US)

(21) Appl. No.: 17/162,220

(22) Filed: Jan. 29, 2021

Related U.S. Application Data
(60) Provisional application No. 63/009,620, filed on Apr. 14, 2020.

(51) Int. Cl. G02B 6/02

(52) U.S. Cl. CPC G02B 6/02042; G02B 6/02047

(57) ABSTRACT

A multicore fiber optic cable comprising of a dual core optical fiber having a dual core optical fiber geometry, the cores are spiraled parallel to one another along the longitudinal axis of the fiber to negate link path length difference, a coating that surrounds the fiber, a buffer tube that surrounds the coated fiber, a strength member that surrounds the buffer tube, and an outer jacket that surrounds the strength member.

### STATEMENT OF GOVERNMENT INTEREST

The invention described herein may be manufactured and used by or for the Government of the United States of America for governmental purposes without payment of any royalties thereon or therefor.

### BACKGROUND

Fiber optic based photonic links are often used in high bandwidth analog and digital communication applications. Photonics and fiber optics offers numerous advantages over traditional radiofrequency hardware and electrical interconnects for various analog link applications. Such advantages include reduced weight, immunity to electromagnetic interference, increased flexibility, larger bandwidth in fiber, and reduced loss in fiber. Many analog photonic link applications have critical sensitivity and linearity requirements. Noise figure, link gain, compression dynamic range and spurious free dynamic range are key performance parameters for analog links. Intensity modulation with direct detection (IMDD) is an analog link modulation scheme where the intensity of an optical source is modulated by the analog signal. Demodulation is achieved through direct detection of the optical carrier and conversion using a photodetector. FIG. 1 (not admitted to be prior art) from Naval Research Laboratory report NRL/MR/5652-07-9065 (incorporated by reference and not admitted to be prior art) allows one to understand the schematic and operation of a traditional unbalanced IMDD analog photonic link 20. Polarization-maintaining optical fiber 21 connects the laser 22 to the Mach-Zehnder modulator (MZM) 24. A single-core single-mode optical fiber 23 connects the MZM 24 to a single photodetector 25. RF i/p=RF input to the MZM 26. RF o/p=RF out 28 from the photodetector. A bias control circuit 27 sets the MZM operating point at quadrature.

Balanced IMDD links offer a performance advantage over traditional unbalanced IMDD links in terms of noise suppression and link gain (see references 1-3 in J. Diehl, et al, “Measurement and discussion of a balanced photonic link utilizing dual-core optical fiber,” Proc. IEEE Avionics and Vehicle Fiber Optics and Photonics Conference, 2019, this reference is not admitted to be prior art). FIG. 2 (not admitted to be prior art) 30 illustrates a balanced IMDD link schematic based on two individual single-core fibers 31 interfaced to the output of a dual-output MZM 32 and to the input of a balanced photodetector 33. Using both output arms of the dual-output MZM results in twice the photocurrent collected. This corresponds to four times (6 dB) more gain. More importantly, common mode noise (such as laser noise or spontaneous emission noise arising from a pre-modulator erbium-doped fiber amplifier) is differenced at the balanced photodetector, resulting in significant noise suppression in a typical link. Efficient use of optical power and noise cancellation is achieved at the same time resulting in higher link gain, lower noise figure, and higher spurious free dynamic range.

Building a balanced link becomes progressively more difficult as the modulation frequency increases. This is due to the ever-tightening phase-tolerance as the modulation signal's frequency increases and wavelength decreases. At frequencies above 10 GHz, maintaining steady balanced phase over any appreciable transmission distance (several meters) is limited by temperature and physical effects on the two individual single-core optical fibers interfaced to the output of a dual-output Mach-Zehnder modulator (MZM) and to the input of a balanced photodetector. Again referring to FIG. 2, any effective change in fiber optic length on the order of micrometers can begin to unbalance a high frequency analog photonic link.

A balanced IMDD analog photonic link based on one dual-core optical fiber can mitigate the temperature and physical effects that cause a high frequency analog photonic link to become unbalanced over any appreciable link distance (see FIG. 3, not admitted to be prior art) 40. With both outputs of the modulator traveling down independent single-mode cores in a single fiber 45, the effects of temperature and mechanical stress is minimized wherein any effect impacting one core would be expected to impact the other core as well.

Fiber optic cable bending is one form of mechanical stress, so therefore fiber optic cable bending can cause the link to become unbalanced. As shown in FIG. 8, in a standard, dual-core optical fiber with the cores 61 traveling straight down the fiber, a net path length difference can be seen over long bend distances. As shown in FIG. 9, by rotating the cores 63 around a central axis 64, the net effect of this path length difference accumulation is limited to the modulus of the spiral length and the total bend length (that is to say the total path length difference cannot be greater than the spiral length 62). The dual-core fiber optic cable design described in this disclosure is meant to minimize differences in path delay due to fiber optic cable bending, thereby mitigating the net effect of bending the cable in any direction when the fiber optic cable is installed on an aerospace platform or other physical structure.

### SUMMARY

The present invention is directed to a balanced photonic link with the needs enumerated above and below.

The present invention is directed to a balanced photonic link based on dual core optical fiber with spiraled cores.

It is a feature of the present invention to provide a balanced photonic link design based on dual core optical fiber with spiraled cores.

It is a feature of the present invention to provide a balanced photonic link design based on a fiber optic cable that has a dual core optical fiber with spiraled cores.

It is a feature of the present invention to provide a cable design with a buffer tube, strength member and outer jacket.

### DRAWINGS

These and other features, aspects and advantages of the present invention will become better understood with reference to the following description and appended claims, and accompanying drawings wherein:

FIG. 1 is a schematic of a traditional intensity modulation with direct detection photonic link based on one single core optical fiber and one photodetector;

FIG. 2 illustrates a balanced IMDD analog photonic link with two single core optical fibers and a balanced photodetector;

FIG. 3 illustrates a balanced IMDD analog photonic link with one dual core optical fiber and a balanced photodetector;

FIG. 4 illustrates a longitudinal cross-section view a fiber optic cable with dual core optical fiber with spiraled cores;

FIG. 5 illustrates a transverse cross-section view of a dual core fiber optic cable;

FIG. 6 illustrates a longitudinal cross section view of the dual core fiber with spiraled cores; and,

FIG. 7 illustrates a balanced IMDD analog photonic link utilizing a dual core optical fiber with spiraled cores. Dual core fiber optic connectors with optical fan-in/fan-out fibers or waveguides couple light into and out of the dual core optical fiber cable.

FIG. 8 shows that for two conventional cores inside of a bent optical fiber, a net accumulation of path length is obtained (the slight difference in the bend radius of each core results in a different arc length).

FIG. 9 shows that for two cores rotating around a central axis, this effect is averaged out, limiting the net path length difference to, at most, one spiral length.

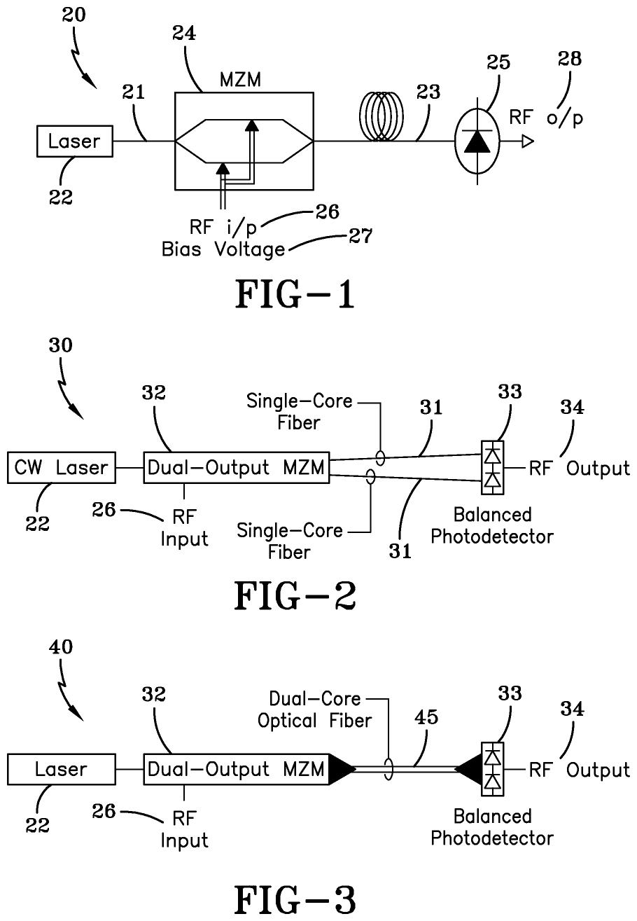

### DESCRIPTION

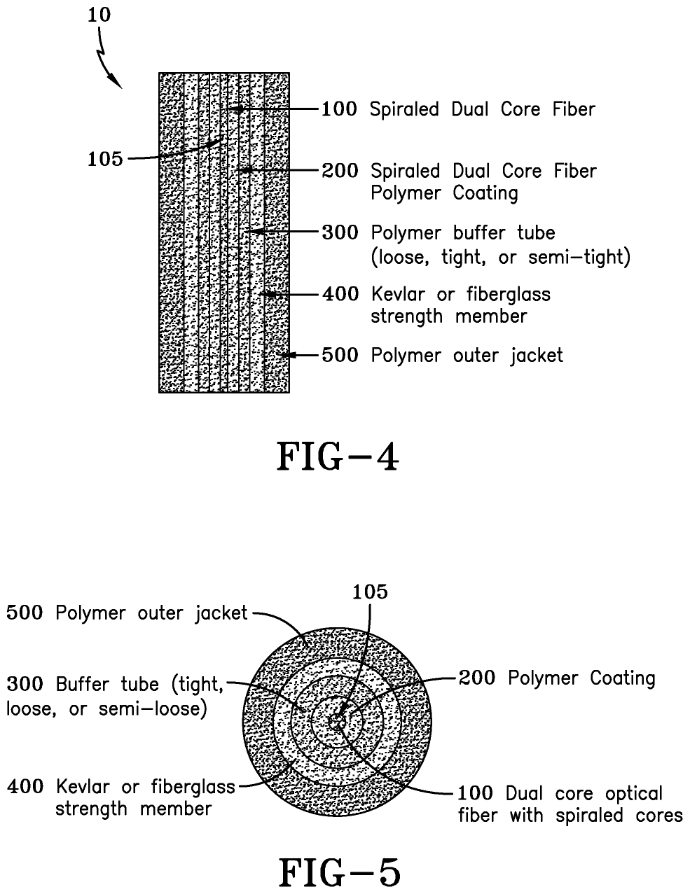

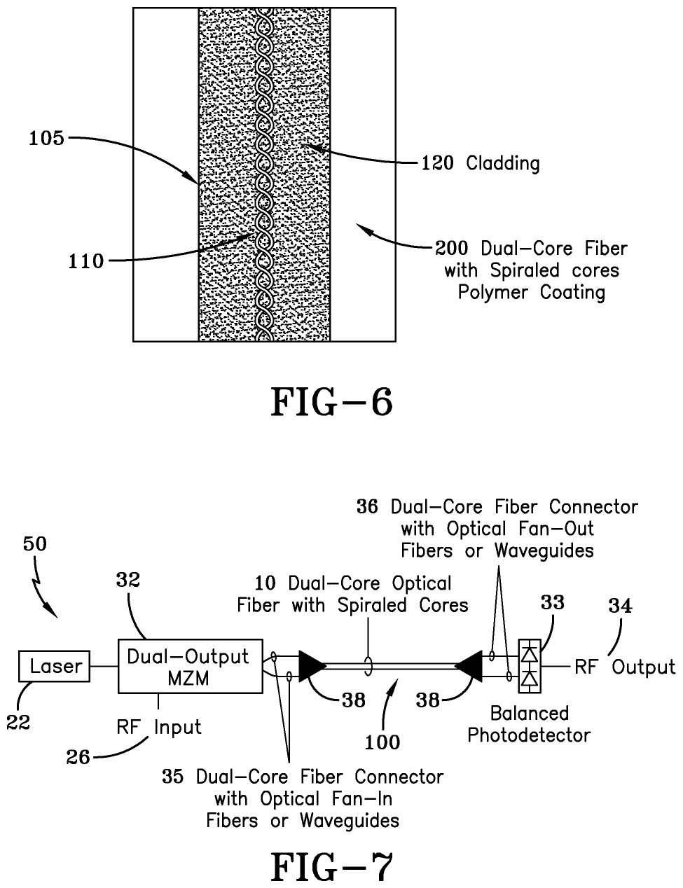

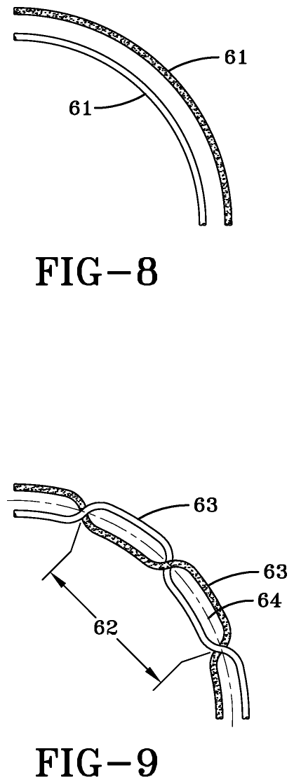

The preferred embodiments of the present invention are illustrated by way of example below and in FIGS. 4-7. As seen in FIG. 4, a multicore fiber optic cable 10 includes a dual core fiber 100, a fiber coating 200, a buffer tube 300, a strength member 400, and an outer jacket 500. The dual core fiber 100 has a fiber outer surface 105. The fiber coating 200 surrounds the fiber outer surface 105 of the dual core fiber 100. The dual core optical fiber 100 has a spiraled dual core optical fiber core geometry 110. The dual core fiber cores are surrounded by a cladding 120. The dual core optical fiber 100 cores are spiraled along the longitudinal axis to negate link path length difference. The buffer 300 surrounds the fiber coating 200 and the dual core optical fiber 100. The strength member 400 and outer jacket 500 surrounds the buffer tube 300. FIG. 7 illustrates a balanced IMDD analog photonic link 50 utilizing multicore fiber optic cable 10 with a dual core fiber 100 with spiraled dual core optical fiber core geometry. Dual core fiber optic connectors 38 with optical fan in 35/fan out 36 fibers or waveguides couple light in to and out of the dual core optical fiber cable 10 with a dual core fiber 100 and spiraled dual core optical fiber core geometry 110.

In the description of the present invention, the invention will be discussed in a military environment; however, this invention can be utilized for any type of application that requires use of fiber optic cable.

The dual core fiber 100 may be, but without limitation, a plastic fiber, glass fiber, or any material practicable. The multicore fiber optic cable 10 may further include a strength member 400 that is disposed within cable.

The buffer tube 300 can be made from polymer, while strength member 400 may be manufactured from fiberglass, Kevlar or any other material practicable. The cable 10 may further include an outer jacket 500 on the outside of all the other elements. The outer jacket 500 may be manufactured from polymer or any other material practicable.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A multicore fiber optic cable comprising of;
a dual core optical fiber having a dual core optical fiber geometry, the cores are spiraled parallel to one another along the longitudinal axis of the fiber to negate link path length difference;
a coating that surrounds the fiber;
a buffer tube that surrounds the coated fiber;
a strength member that surrounds the buffer tube; and
an outer jacket that surrounds the strength member.

2. The multicore fiber optic cable of claim 1, wherein the cable is employed in a balanced photonic link.
